(19) United States
(12) Patent Application Publication
(10) Pub. No.: US 2012/0216189 A1
(43) Pub. Date: Aug. 23, 2012

(54) Methods, Devices and Computer Program Products for Emulating a Physical Hard Drive as Multiple Virtual Hard Drives

(76) Inventors: Subash Kalbarga, Suwanee, GA (US); Vinothkumar Sundaramoorthy, Norcross, GA (US); Rajasekhar Jonna, Duluth, GA (US)

(21) Appl. No.: 13/032,055

(22) Filed: Feb. 22, 2011

(51) Int. Cl. G06F 9/455

(52) U.S. Cl. 718/1

(57) ABSTRACT

A virtual machine includes a virtual operating system operating in multiple modes. A hypervisor emulates a physical hard drive to the virtual operating system as multiple virtual hard drives. The hypervisor controls access to the multiple virtual hard drives by the virtual operating system. Each of the multiple virtual hard drives is dedicated to a different one of the multiple modes of operation. Each virtual hard drive is allocated a portion of storage space by the hypervisor that is a subset of a total amount of storage space available in the physical hard drive. Changes to a subset of the storage space allocated to a virtual hard drive dedicated to one mode of operation do not affect changes to a subset of the storage space allocated to another virtual hard drive dedicated to another mode of operation.

### TECHNICAL FIELD

The present disclosure relates generally to computing systems, and more particularly, to virtualization of hard disk space in a computing system.

### BACKGROUND

Computers include general purpose central processing units (CPUs) that are designed to execute a specific set of system instructions. A group of processors that have similar architecture or design specifications may be considered to be members of the same processor family.

Each family of processors executes instructions that are unique to that processor family. The uniqueness of the processor families typically results in incompatibility among other elements of hardware architecture. Because of the uniqueness of the processor instruction set and computer system hardware architecture, application software programs are typically written to run on a particular computer system running a particular operating system.

To expand the number of operating systems and application programs that run on a computer system, a virtualized computer system has been developed. In a virtualized computer system, a given computer having one type of CPU, called a host, includes an emulator program that allows the host computer to emulate the instructions of an unrelated type of CPU, called a guest. Thus, the host computer executes an application that will cause one or more host instructions to be called in response to a given guest instruction. The host computer can run both software designed for its own hardware architecture and software written for a computer having an unrelated hardware architecture. In this type of arrangement, the guest computer system is a “virtual machine” as it only exists in the host computer system as a pure software representation of the operation of one specific hardware architecture.

A hypervisor is a control program that exists near the kernel level of a host operating system and operates to allow one or more guest operating systems, other than the host operating system, to use the hardware of the computer system, including the processor and physical hard drive of the computer system. A hypervisor emulates the operating environment of the guest operating system so that the guest operating system believes that it is operating in its customary hardware and/or operating system environment and that it is in logical control of the computer system.

While virtualization of hardware provides advantages, it may result in loss of performance because the virtual operating system does not directly access the physical hardware.

It is with respect to these and other considerations that the disclosure presented herein has been made.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

According to one embodiment, a computing system comprises a physical hard drive for storing data, a memory for storing applications, and a processor coupled to the memory for executing the applications using the stored data. The applications include a virtual machine including a virtual operating system operating in multiple modes and a hypervisor emulating the physical hard drive to the virtual operating system as multiple virtual hard drives. The hypervisor controls access to the multiple virtual hard drives by the virtual operating system.

According to another embodiment, a method for emulating a physical hard drive in a computing device includes executing, by a processor, an application for providing a virtual machine including a virtual operating system operating in multiple modes and executing, by the processor, a hypervisor application for emulating the physical hard drive to the virtual operating system as multiple virtual hard drives. The hypervisor application controls access to the multiple virtual hard drives by the virtual operating system.

According to another embodiment, a computer program product includes a storage medium upon which instructions are recorded that, when executed by a processor, perform a method for emulating a physical hard drive in a computing device. The method includes executing an application for providing a virtual machine including a virtual operating system operating in multiple modes and executing a hypervisor application for emulating the physical hard drive to the virtual operating system as multiple virtual hard drives. The hypervisor application controls access to the multiple virtual hard drives by the virtual operating system.

### BRIEF DESCRIPTION OF THE DRAWINGS

FIG. 1 illustrates a conventional virtualized environment;

FIG. 2 illustrates a virtualized environment in which a hypervisor emulates multiple virtual hard drives to a virtual operating system according to an exemplary embodiment;

FIGS. 3A-3C illustrate an allocation of a physical hard drive according to an exemplary embodiment.

FIGS. 4A-4E illustrate examples of portions of virtual hard drives running in different modes according to an exemplary embodiment.

FIGS. 5A and 5B illustrate representations of data stored in a virtual hard drive according to an exemplary embodiment.

FIG. 6 is a block diagram of a computing system in which a virtualized environment may be implemented according to exemplary embodiments.

FIG. 7 illustrates a method for emulating a physical hard drive according to an exemplary embodiment.

### DETAILED DESCRIPTION

Detailed exemplary embodiments are disclosed herein. It must be understood that the embodiments described and illustrated are merely examples that may be embodied in various and alternative forms, and combinations thereof. As used herein, the word “exemplary” is used expansively to refer to embodiments that serve as examples or illustrations. The figures are not necessarily to scale and some features may be exaggerated or minimized to show details of particular components. Specific structural and functional details disclosed herein are not to be interpreted as limiting.

According to exemplary embodiments, a physical hard drive is emulated to a virtual operating system as multiple virtual hard drives, each virtual hard drive dedicated to a different mode of operation of the virtual operating system. Virtualizing the physical hard drive in this manner allows a virtual operating system to operate in different modes without requiring multiple copies of the operating system or multiple licenses for the operating system. Virtualizing only the hard drive rather than virtualizing all of the physical hardware allows maximum performance to be obtained from the other hardware, as the other hardware is directly accessed by the operating system.

To illustrate aspects and advantages of exemplary embodiments, consider a user of a computer system in a work environment. The user may depend on the computer system for office-related work, such as checking and sending work-related emails, conducting conferences, discussions, and meetings with co-workers, development and/or compilation associated with work-related tasks, research and development, and other office-related work, depending on the nature of employment. In addition to using the computer system for office-related tasks, the user may depend on the computer system for personal use, such as checking and sending personal emails, organizing and sharing photographs, downloading, storing and streaming music and videos (including synchronization with mobile communication devices, such as IPods and IPhone), online shopping, chatting and texting, and other personal tasks.

As use of a computer system for personal use may affect use of a computer system for work use, and vice versa, it may be desirable to have separate computer devices dedicated to each mode. This may be achieved by having two different physical computers, one dedicated to work, and one dedicated to play. However, having two separate devices may be difficult and cumbersome.

As an alternative, a single computing device may be used, with two different copies of an operating system, such as Microsoft Windows OS, installed. One copy of Windows OS may be used for office-related work, and another copy of Windows OS may be used for personal tasks. Two operating systems may be used on the same device through virtualization.

To aid in understanding of virtualization, consider, from a conceptual perspective, that a computer system generally comprises one or more layers of software running on a foundational layer of hardware. This layering is done for reasons of abstraction. Be defining the interface for a given layer of software, that layer can be implemented differently by other layers above it. In a well designed computer system, each layer only knows about (and only relies upon) the immediate layers beneath it. This allows a layer to be replaced without negatively impacting the layers above that layer.

The flexibility of layered software allows a virtual machine to present a virtual hardware layer that is in fact another software layer. In this way, a virtual machine can create the illusion for the software layers above it that the software layers are running on their own private computer system, and thus the virtual machines allow multiple “guest systems” to run concurrently on a single “host system”.

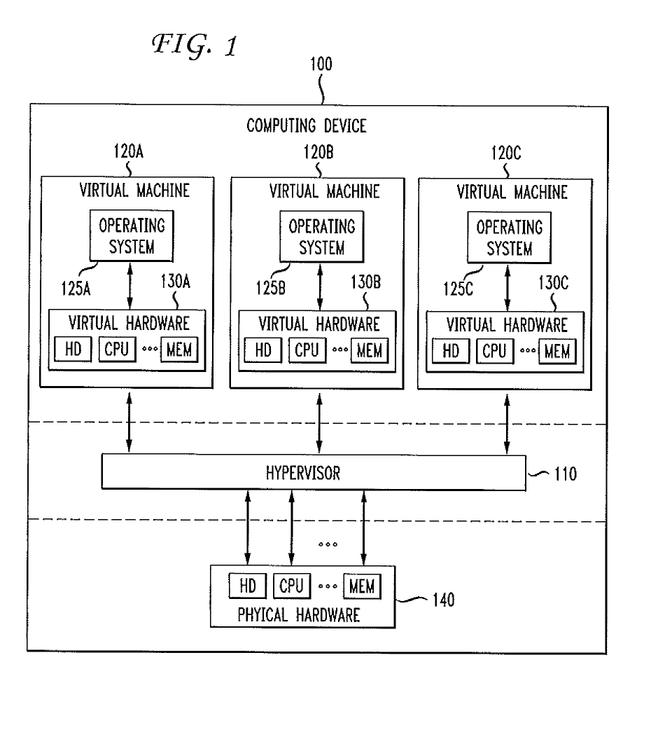

FIG. 1 is a diagram representing the logical layers of the hardware and software architecture in a conventional virtualized environment. A computing device 100 includes a hypervisor layer, a virtualization layer, and a hardware layer.

The hypervisor layer includes a hypervisor 110 that allows and manages access to a number of physical resources in the hardware layer (e.g., processor, memory, and hard drive) by at least one virtual machine executing in the virtualization layer. The hypervisor 110 functions as a software-based hardware abstraction layer that controls physical resources and firmware resources of the virtual hardware, allowing each guest operating system to interact with the virtual hardware and providing a user interface.

The virtualization layer includes virtual or guest machines 120A, 120B, and 120C including virtual operating systems 125A, 125B, and 125C and a plurality of virtual hardware resources 130A, 130B and 130C allocated to the virtual operating systems 125A, 125B, and 125C, respectively. The virtual hardware resources 130A, 130B, and 130C included may each include a processor, a virtual hard drive, a virtual memory, etc.

The hardware layer includes physical hardware 140 including, e.g., a hard drive for storing data, a processor for executing applications, and a memory which may include an operating system which controls scheduling of tasks and access to system resources.

In the computing system shown in FIG. 1, there are three virtual machines 120A, 120B, and 120C, each having its own dedicated virtual hardware 130A, 130B, and 130C and its own virtual operating system 125A, 125B, and 125C, respectively. While having three virtual operating systems enables operation of the computing system 100 in three different modes, virtualization of all of the hardware components results in some loss of performance. Also, a separate software license is needed for each virtual operating system 125A, 125B, and 125C.

According to an exemplary embodiment, the computing device may operate in different modes using a single virtual operating system by emulating multiple copies of a subset of physical hardware, such as the hard disk drive, as virtual hardware to the virtual operating system. Emulating a subset of physical hardware provides advantages, such as virus containment and a reduction is the number of software licenses needed, while minimizing loss of performance.

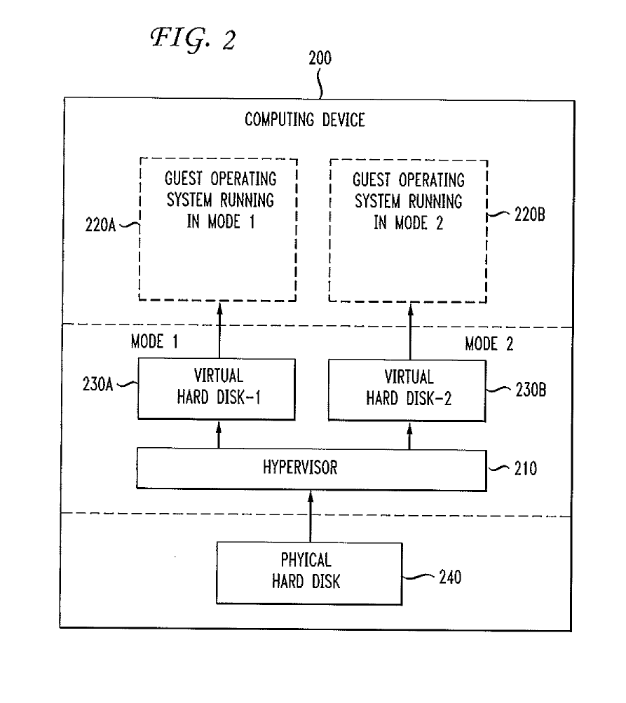

FIG. 2 illustrates a virtualized environment in which a hypervisor emulates multiple virtual hard drives to a virtual operating system according to an exemplary embodiment. The computing system 200 of FIG. 2 is similar to that shown in FIG. 1, in that it includes a virtual layer having a virtual operating system 220, a hypervisor layer having a hypervisor 210, and a hardware layer having a physical hard disk 240, among other hardware (not shown in the interest of simplifying the illustration). However, in the computing system 200, multiple virtual hard drives 230A and 230B are emulated for the same virtual operating system 220 operating in different modes (Modes 1 and 2). The virtual operating system 220 operating in different modes (as represented by dashed lines) avoids the need for multiple operating systems licenses to have the benefit of hard disk space allocated for different modes of operation. While FIG. 2 illustrates the virtual operating system 220 operating in two different modes, it should be appreciated that the virtual operating system 220 may operate in any number of desired modes, with a virtual hard drive emulated for each mode of operation.

According to an exemplary embodiment, the computing device 200 can be running any host operating system and any virtual operating system, such as any of the versions of the MICROSOFT WINDOWS OPERATIN SYSTEMS, including, e.g., any version of the Windows, Unix and Linux operating systems, any version of the MAC OS for Macintosh computers, any embedded operating system, any real-time operating system, any open source operating system, any propriety operating system, any operating system for mobile computing devices, or any other operating system capable of running of the computing device and performing the operations descries herein.

The computing system 200 may include any workstation, telephone, desktop computer, laptop, or notebook computer, server, handheld computer, mobile telephone or other portable telecommunications device, media playing device, gaming system, mobile computing device, or any other type and/or form of computing, telecommunications, or media device that is capable of communication The computing system 200 has sufficient processor power and memory capability to perform the operations described herein. The computing device 200 may execute, operate or otherwise provide an application, which can be any type and/or form of software, program, or executable instructions.

According to an exemplary embodiment, hard disk virtualization is provided at the hypervisor layer. In the embodiments that are described below, only one guest operating system is virtualized. Thus, only one license to the operating system software is needed. However, it should be appreciated that multiple guest operating systems may be virtualized, in which case multiple software licenses would be needed. In either event, multiple virtual hard drives are provided for each virtual operating system, thus reducing the number of software licenses needed while ensuring optimal performance.

As an illustrative example, consider a physical hard disk having 25 GB of memory available. Portions of the physical hard drive may be allocated for each virtual hard drive. For example, 10 GB may be allocated for reading/writing by the virtual hard drive 1 in a work mode, and 10 GB may be allocated for reading/writing by virtual hard drive 2 in a play mode. The remaining 5 GB may be reserved as read-only space which may be used by either virtual hard drive. It should be appreciated that this allocation of space is provided only as an example, and that the amount of space allocated to each virtual hard drive need not be the same.

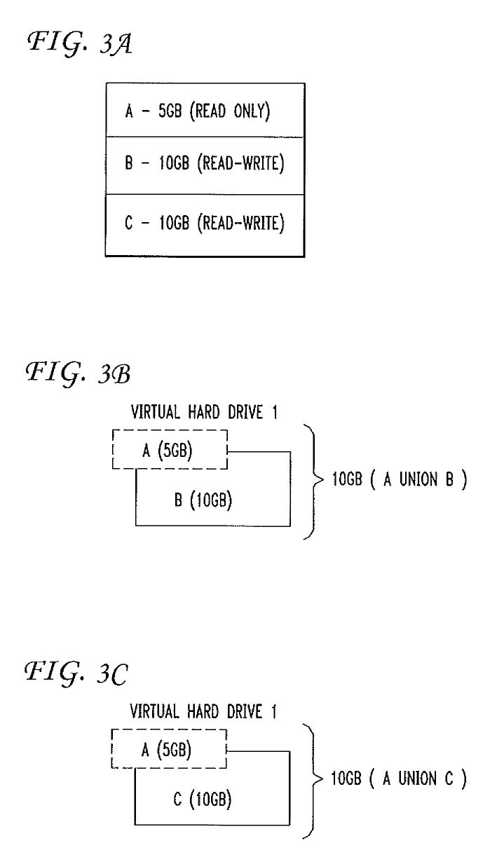

An illustration of such a hard drive is shown in FIG. 3A. The diagram depicts a physical hard drive which contains three parts: A (Read only), B (Read-Write) and C (Read-Write). Portion A may contain the basic Windows Operating system, Portion B may contain writeable data for use in Mode 1, and Portion C may contain writeable data for use in Mode 2.

According to an exemplary embodiment, each virtual hard drive is dedicated for use in one mode of operation by the virtual operating system 220. Referring to FIG. 3B, virtual hard drive 1 may be considered the union of Portions A and B, and referring to FIG. 3C, virtual hard drive 2 may be considered the union of Portions A and C. In FIGS. 3A-3C, Portion A may be considered the base.

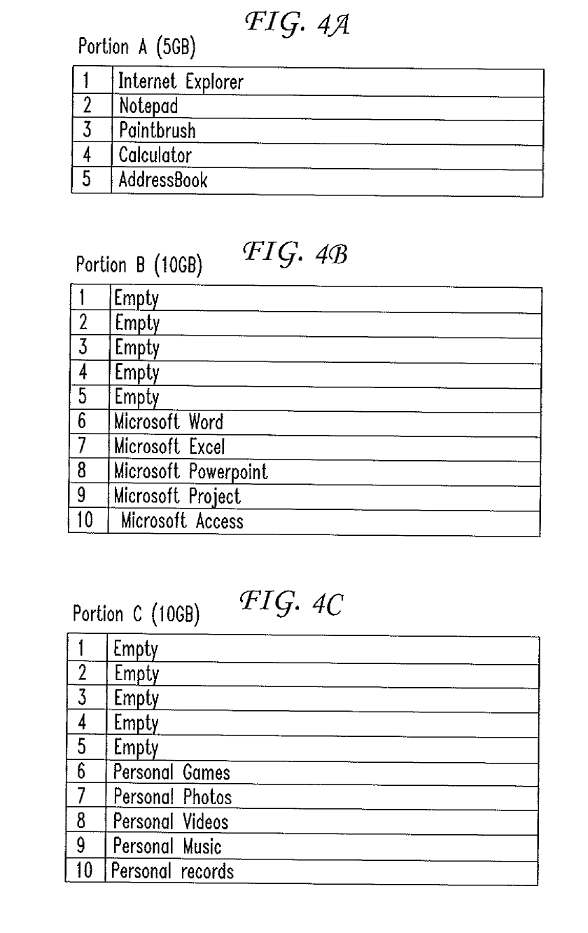

FIGS. 4A-4E illustrate examples of data that may be stored in each portion of the physical hard drive. Referring to FIG. 4A, Portion A may include 5 sectors: sector 1 storing Internet Explorer software, sector 2 storing Notepad software, sector 3 storing Paintbrush software, sector 4 storing Calculator software, and sector 5 storing AddressBook software.

Referring to FIG. 4B, Portion B is allocated to virtual hard disk 1 and may include 10 sectors. The first five sectors may be empty. Sector 6 may include Microsoft Word software, sector 7 may store Microsoft Excel software, sector 8 may store Microsoft PowerPoint software, sector 9 may store Microsoft Project, and sector 5 may store Microsoft Access.

Referring to FIG. 4C, Portion C is allocated to virtual hard disk 2 and may include 10 sectors. Sectors 1-5 are empty, sector 6 may store personal games, sector 7 may storage personal photos, sector 8 may store personal videos, sector 9 may store personal music, and sector 10 may store personal records.

Assume that the computing device 200 is operating in work mode. In this mode, the guest operating system has access to the information stored in Portions A and B of the physical hard drive, emulated as virtual hard drive 230A. This may be understood with reference to FIG. 4D. Thus, when the guest operating system 220 operating in Mode 1 tries to read sectors 1 to 5 from the physical hard drive 240, the data from Portion A is read, and if the same guest operating system operating in the same mode tries to read the next 6 to 10 sectors, the data from Portion B is read and given to the guest operating system 220. So, for example, if a user wants to install MS Office in this mode, the installation data will go to Portion B.

In the personal use mode, the guest operating system 220 has access to Portions A and C of the physical hard drive 240, virtualized as virtual hard drive 230B 2. This may be understood with reference to FIG. 4D. When the guest operating system 220 operating in Mode 2 tries to read sectors 1 to 5 of the physical hard drive 240, the data from Portion A is read, and if the same guest operating system operating in the same mode tries to read the next 6 to 10 sectors, the data from Portion C is read and given to the guest operating system 220. So, for example, if a user wants to install personal games in this mode, the installation data will go to Portion C.

According to an exemplary embodiment, since the hard drive is virtualized, a virus is prevented from infecting the physical hard drive. Any download or other action that infects the hard disk space allocated to Mode 1 (including Portions A and B) will not affect the hard disk space allocated to Mode 2 (including Portions A and C), and vice versa. Also, a virus in the hard disk space allocated to Mode 1 may be corrected without affecting the hard disk space allocated to Mode 2 and vice versa.

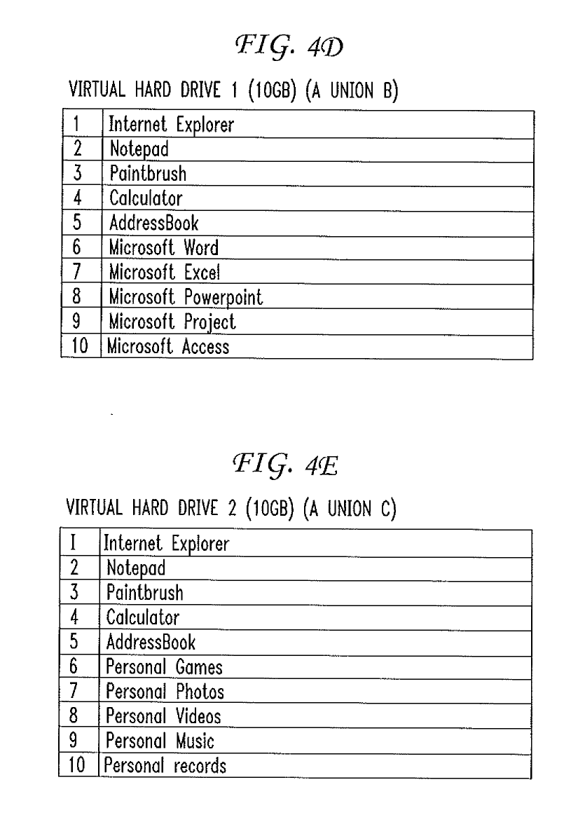

According to exemplary embodiments, a table may be maintained, e.g., in memory, that represents the sector number and its location. As an example, FIG. 5A shows a table having locations of data, sector numbers, and the data stored. Referring to FIG. 5A, the data in Portion A is accessible via the guest operating system 220 in Modes 1 and 2, and the data in Portion B is accessible via the guest operating system 220 in Mode 2.

The table may be updated to indicate changes to data stored in each portion. Thus, for example, if a user wants to delete or replace the data stored in sectors of Portion A such that these sectors are useable by the guest operating system 220 operating in Mode 1, the entries for the sectors that the user desires to use in Mode 1 are marked as being part of Portion B. Thus, for example, if the user wants to have access to sector 2 to delete the Notepad software and access to sector 3 to replace the PaintBrush software with Photoshop in Mode 1, these sectors are marked as being part of Portion B. In this example, if the guest operating system 220 were to request data in sectors 2 or 3 while operating in Mode 1, the data from Portion B would be read and given to the guest operating system 220. The same sort of marking of sectors and reading of sectors would hold for the guest operating system 220 operating in Mode 2.

According to an exemplary embodiment, by emulating a virtual hard disk drive, snapshots of the hard drive space may be taken at any time. A snapshot, as this terminology is used in this disclosure, refers to a capture of changes to space in a hard disk drive. A snapshot differs from a copy of a hard disk drive in that a copy includes an entire sector. A copy is stored in a remote location, e.g., for backup. However, storing a copy requires an amount of memory equivalent to the amount of space on the hard disk drive. In contrast, a snapshot only includes changes to a sector and thus requires less memory to store.

Thus, for example, if a virus infects a sector of a hard drive, a snapshot of that sector of the hard drive may be taken such that it is frozen in time, and only the contents of the affected sector may be stored. The contents of the affected sector may be stored in another sector. According to an exemplary embodiment, the hypervisor 210 may take snapshots which keep track of writes to the hard drive 240

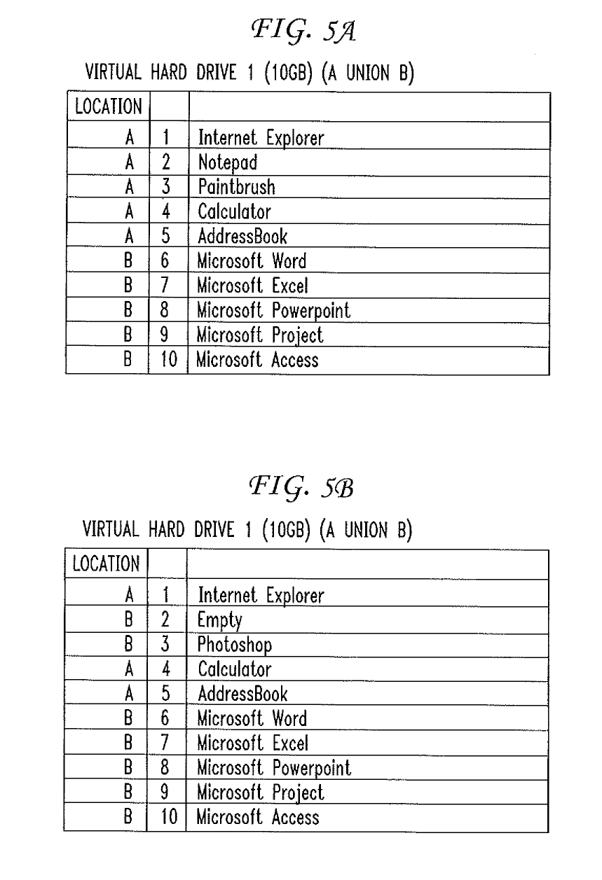

FIG. 6 is a block diagram of a computing device 600 (which may be the same as the device 200) in which exemplary embodiments may be implemented. A computing device 600 includes a processor 610 that receives inputs, e.g., user requests, and transmits outputs, e.g., responses to user requests via I/O Data Ports 620. The I/O Data Ports 620 can be implemented with, e.g., an interface including an antenna or other suitable type of transceiver through which data and signals may be transmitted and received wired and/or wirelessly.

The computing device 600 also includes a physical hard drive 680. The processor 610 communicates with the memory 630 and the hard drive 680 via, e.g., an address/data bus (not shown). The processor 610 can be any commercially available or custom microprocessor. The memory is 630 is representative of the overall hierarchy of memory devices containing the software and data used to implement the functionality of the device 600. The memory 630 can include, but is not limited to, the following types of devices: processor registers, processor cache, RAM, ROM, PROM, EPROM, EEPROM, flash memory, SRAMD, DRAM other volatile memory forms, and non-volatile, semi-permanent or permanent memory types; for example, tape-based media, optical media, solid state media, hard disks, combinations thereof, and the like.

As shown in FIG. 6, the memory 630 may include several categories of software and data used in the device 600, including applications 640, a database 650, an operating system (OS) 660, and input/output (I/O) device drivers 670. As will be appreciated by those skilled in the art, the OS 660 may be any operating system for use with a data processing system, e.g., a Windows Operating System. The I/O device drivers 670 may include various routines accessed through the OS 660 by the applications 640 to communicate with devices, and certain memory components. The applications 640 can be stored in the memory 630 and/or in a firmware (not shown) as executable instructions, and can be executed by the processor 610. The applications 640 include various programs that implement the various features of the device 600, including, e.g., applications for providing a virtual operating system and an application for emulating physical hardware, such as the hypervisor. The database 650 represents the static and dynamic data used by the applications 640, the OS 660, the 110 device drivers 670 and other software programs that may reside in the memory. The database 650 may store a table indicating how portions of the hard drive 680 are allocated as virtual hard drives for different modes of operation. This data may be used by the processor 610 for executing the hypervisor in emulating the hard drive 680 as the virtual hard drives to the operating system 220 (shown in FIG. 2)

While the memory 630 is illustrated as residing proximate the processor 610, it should be understood that at least a portion of the memory 630 can be a remotely accessed storage system, for example, a server on a communication network, a remote hard disk drive, a removable storage medium, combinations thereof, and the like. Thus, any of the data, applications, and/or software described above can be stored within the memory 630 and/or accessed via network connections to other data processing systems (not shown) that may include a local area network (LAN), a metropolitan area network (MAN), or a wide area network (WAN), for example.

It should be understood that FIG. 6 and the description above are intended to provide a brief, general description of a suitable environment in which the various aspects of some embodiments of the present disclosure can be implemented. While the description refers to computer-readable instructions, the present disclosure also can be implemented in combination with other program modules and/or as a combination of hardware and software in addition to, or in stead of, computer readable instructions. The term “application,” or variants thereof, is used expansively herein to include routines, program modules, programs, components, data structures, algorithms, and the like. Applications can be implemented on various system configurations, including single-processor or multiprocessor systems, minicomputers, mainframe computers, personal computers, hand-held computing devices, microprocessor-based, programmable consumer electronics, combinations thereof, and the like.

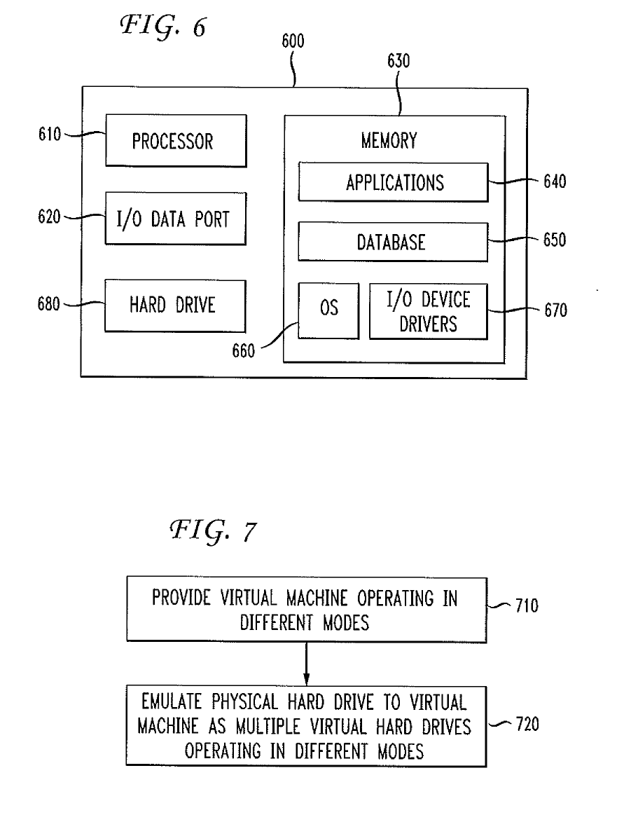

FIG. 7 is a flow chart illustrating a method for controlling access to physical hardware in a computing device according to an exemplary embodiment. It should be understood that the steps or other interactions of the illustrated method are not necessarily presented in any particular order and that performance of some or all the steps in an alternative order is possible and is contemplated. The steps have been presented in the demonstrated order for ease of description and illustration. Steps can be added, omitted and/or performed simultaneously without departing from the scope of the appended claims. It should also be understood that the method can be ended at any time. In certain embodiments, some or all steps of the method, and/or substantially equivalent steps can be performed by execution of computer-executable instructions stored or included on a non-transitory computer-readable medium.

Referring to FIG. 7, the method includes providing a virtual machine including a virtual operating system operating in multiple modes at step 710. The virtual machine may be provided by executing an application for providing a virtual operating system by a host machine, e.g., by the processor 680. The method further includes executing a hypervisor application for emulating the physical hard drive to the virtual operating system as multiple virtual hard drives. The hypervisor application, which may be executed by the processor 680, controls access to the multiple virtual hard drives by the virtual operating system.

The law does not require and it is economically prohibitive to illustrate and teach every possible embodiment of the present claims. Hence, the above-described embodiments are merely exemplary illustrations of implementations set forth for a clear understanding of the principles of the invention. Variations, modifications, and combinations may be made to the above-described embodiments without departing from the scope of the claims. All such variations, modifications, and combinations are included herein by the scope of this disclosure and the following claims.

What is claimed is:

1. A computing system comprising:
a physical hard drive for storing data;
a memory for storing applications; and
a processor coupled to the memory for executing the applications using the stored data, wherein the applications include:
a virtual machine including a virtual operating system operating in multiple modes;
a hypervisor emulating the physical hard drive to the virtual operating system as multiple virtual hard drives, wherein the hypervisor controls access to the multiple virtual hard drives by the virtual operating system.

2. The computing system of claim 1, wherein each of the multiple virtual hard drives is dedicated to a different one of the multiple modes of operation.

3. The computing system of claim 1, wherein each virtual hard drive is allocated a portion of storage space by the hypervisor that is a subset of a total amount of storage space available in the physical hard drive.

4. The computing system of claim 3, wherein one portion of the storage space is allocated to one virtual hard drive dedicated to one mode of operation and another portion of the storage space is allocated to another virtual hard drive dedicated to another mode of operation.

5. The computing system of claim 4, wherein changes to the one portion of the storage space do not affect the other portion of storage space, and changes to the other portion of storage space do not affect the one portion of the storage space.

6. The computing system of claim 3, wherein each virtual hard drive is allocated a read-only portion of storage space and a read-write portion of storage space.

7. The computing system of claim 6, wherein each virtual hard drive is allocated the same read-only portion of storage space and different read-write portions of storage space.

8. A method for emulating a physical hard drive in a computing device, comprising:
executing, by a processor, an application for providing a virtual machine including a virtual operating system operating in multiple modes;
executing, by the processor, a hypervisor application for emulating the physical hard drive to the virtual operating system as multiple virtual hard drives, wherein the hypervisor controls access to the multiple virtual hard drives by the virtual operating system.

9. The method of claim 8, wherein each of the multiple virtual hard drives is dedicated to a different one of the multiple modes of operation.

10. The method of claim 8, wherein each virtual hard drive is allocated a portion of storage space by the hypervisor that is a subset of a total amount of storage space available in the physical hard drive.

11. The method of claim 9, wherein one portion of the storage space is allocated to one virtual hard drive dedicated to one mode of operation and another portion of the storage space is allocated to another virtual hard drive dedicated to another mode of operation

12. The method of claim 11, wherein changes to the one portion of the storage space do not affect the other portion of storage space, and changes to the other portion of storage space do not affect the one portion of the storage space.

13. The method of claim 10, wherein each virtual hard drive is allocated a read-only portion of storage space and a read-write portion of storage space and each virtual hard drive is allocated the same read-only portion of storage space and different read-write portions of storage space.

14. A computer program product including a storage medium upon which instructions are recorded that, when executed by a processor perform a method for emulating a physical hard drive in a computing device, the method comprising:
executing an application for providing a virtual machine including a virtual operating system operating in multiple modes;
executing a hypervisor application for emulating the physical hard drive to the virtual operating system as multiple virtual hard drives, wherein the hypervisor application controls access to the multiple virtual hard drives by the virtual operating system.

15. The computer program product of claim 14, wherein each of the multiple virtual hard drives is dedicated to a different one of the multiple modes of operation.

16. The computer program product of claim 14, wherein each virtual hard drive is allocated a portion of storage space by the hypervisor that is a subset of a total amount of storage space available in the physical hard drive.

17. The computer program product of claim 16, wherein one portion of the storage space is allocated to one virtual hard drive dedicated to one mode of operation and another portion of the storage space is allocated to another virtual hard drive dedicated to another mode of operation.

18. The computer program product of claim 17, wherein changes to the one portion of the storage space do not affect the other portion of storage space, and changes to the other portion of storage space do not affect the one portion of the storage space.

19. The computer program product of claim 16, wherein each virtual hard drive is allocated a read-only portion of storage space and a read-write portion of storage space.

20. The computer program product of claim 19, wherein each virtual hard drive is allocated the same read-only portion of storage space and different read-write portions of storage space.
